(19) United States
(12) Patent Application Publication
(10) Pub. No.: US 2004/0048185 A1
(43) Pub. Date: Mar. 11, 2004

(54) Heat-sensitive recording material

(75) Inventors: Hisao Yamada, Shizuoka-ken (JP); Hiroshi Sato, Shizuoka-ken (JP); Yoshimitsu Arai, Shizuoka-ken (JP); Kimi Ikeda, Shizuoka-ken (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD

(21) Appl. No.: 10/650,771

(22) Filed: Aug. 29, 2003

(30) Foreign Application Priority Data
Sep. 2, 2002 (JP) 2002-256528

(51) Int. Cl. G03C 1/52; G03C 1/72

(52) U.S. Cl. 430/138; 430/151; 430/171; 430/182; 430/183

(57) ABSTRACT

A heat-sensitive recording material containing a support and a heat-sensitive recording layer formed on the support, the heat-sensitive recording layer including a diazonium salt and a coupler that thermally reacts with the diazonium salt to develop color. The coupler contains a compound represented by the following general formula (1):

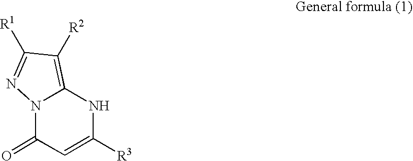

wherein R¹ and R² each independently represent one selected from the group consisting of a hydrogen atom, a halogen atom, an aryl group, an alkyl group, a cyano group, an acyl group, a carbamoyl group, an alkoxycarbonyl group, an aryloxycarbonyl group, an acyloxy group, an alkoxy group, an aryloxy group, an alkylthio group, an arylthio group, a sulfamoyl group, an alkylsulfonyl group, an arylsulfonyl group, an alkylphosphoryl group, an arylphosphoryl group, and an amino group; and R³ represents one selected from the group consisting of an alkoxy group, an aryloxy group, and an alkylamino group.

### CROSS-REFERENCE TO RELATED APPLICATION

This application claims priority under 35USC 119 from Japanese Patent Application No. 2002-256528, the disclosure of which is incorporated by reference herein.

### BACKGROUND OF THE INVENTION

1. Field of the Invention

The present invention relates to a heat-sensitive recording material using a diazonium salt and a coupler as color-developing components, and particularly to a novel, magenta color-developing type, diazo heat-sensitive recording material excellent in light resistance of image portion.

2. Description of the Related Art

Magenta color-developing type, heat-sensitive recording materials with high image density and excellent light resistance of image portion have been strongly demanded in accordance with improvement in performance of heat-sensitive recording materials.

Diazonium salts are remarkably high in chemical activities, and easily react with a compound referred to as coupler such as a phenol derivative and a compound with an active methylene group, to form an azo dye. Additionally, the diazonium salts have photosensitivity, and are decomposed and deactivated by light irradiation. Therefore, the diazonium salts have been used for a long time for optical recording materials which are typified by diazo copies (see Shashin Kogaku no Kiso -Higinen Shashin Hen-, edited by Society of Photographic Science and Technology of Japan, Corona Publishing Co., Ltd., 1982, Page 89 to 117 and 182 to 201).

Further, the diazonium salts have been applied to recording materials requiring image fixation by utilizing their properties of decomposed and deactivated by light irradiation in recent years. A light fixation type, heat-sensitive recording material, in which the diazonium salt and the coupler are heated in accordance with image signal, reacted to form an image, and irradiated by a light to fix the image, has been proposed and known as the typical example (see e.g., Journal of The Institute of Image Electronics Engineers of Japan (Gazo Denshi Gakkai Shi), Vol. 11, No. 4, 1982, Page 290 to 296).

However, in the recording materials using the diazonium salt as a color-developing component, the diazonium salt is remarkably high in activities, and thereby gradually heat-decomposed to lose the reactivity in even dark places. Thus, the recording materials have disadvantages of short shelf life as a recording material. An example for overcoming this disadvantage is a method of encapsulating the diazonium salt in microcapsules. In this method, the diazonium salt is separated from substances such as water and bases that promote decomposition, whereby the shelf life can be drastically improved (see e.g., Electrophotography (Journal of The Society of Electrophotography of Japan, Denshi Shashin Gakkai Shi), Vol. 26, No. 2 (1987) Page 115 to 125).

When the microcapsules have a wall made of a material having a glass transition temperature slightly higher than a room temperature, the wall is substance-impermeable at a room temperature and substance-permeable at a glass transition temperature or higher. Examples of such a material include a urea resin and a urethane resin. These microcapsules are called as a heat response microcapsule and can be utilized for the heat-sensitive recording materials. Thus, when the recording material is formed by coating a support with a heat-sensitive recording layer comprising the coupler, a base and the heat response microcapsule containing the diazonium salt, the diazonium salt can be stable for a long period, a colored image can be easily formed by heating, and further, the image can be fixed by light irradiation.

As described above, the diazonium salts can be drastically improved in the stability by the microcapsulation.

JP-A No. 2000-153671 discloses a purple to cyan color-developing type, diazo heat-sensitive recording material excellent in the image shelf life and image-fixing property, which uses a particular pyrazolopyrimidinone compound as the coupler for the diazonium salt. However, this document discloses only the purple to cyan color-developing type recording material, and does not disclose a magenta color-developing type, heat-sensitive recording material with high image density and excellent light resistance of image.

### SUMMARY OF THE INVENTION

An object of the present invention is to respond to the above-mentioned demands, thereby providing a novel, magenta color-developing type, diazo heat-sensitive recording material with high image density and excellent light resistance of image.

The inventors have focused attention on couplers to attain the above object, and by selecting a particular coupler, have completed a heat-sensitive recording material, which provides a magenta color and exhibits high image density and remarkably high light fastness of image portion. Embodiments of a heat-sensitive recording material of the invention will be described below.

A first aspect of the invention is to provide a heat-sensitive recording material containing a support and a heat-sensitive recording layer formed on the support, the heat-sensitive recording layer including a diazonium salt and a coupler that reacts with the diazonium salt to develop color, wherein the coupler contains a compound represented by the following general formula (1):

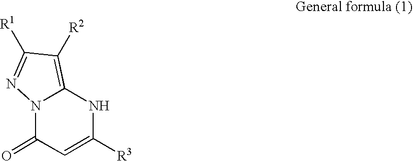

In general formula (1), R¹ and R² each independently represent one selected from the group consisting of a hydrogen atom, a halogen atom, an aryl group, an alkyl group, a cyano group, an acyl group, a carbamoyl group, an alkoxycarbonyl group, an aryloxycarbonyl group, an acyloxy group, an alkoxy group, an aryloxy group, an alkylthio group, an arylthio group, a sulfamoyl group, an alkylsulfonyl group, an arylsulfonyl group, an alkylphosphoryl group, an arylphosphoryl group, and an amino group; and R³ represents one selected from the group consisting of an alkoxy group, an aryloxy group, and an alkylamino group.

A second aspect of the invention is to provide the heat-sensitive recording material of the first aspect, wherein the coupler contains a compound represented by the following general formula (2):

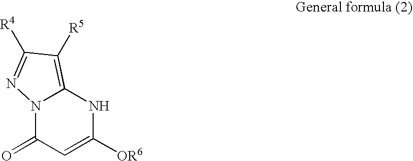

In general formula (2), R⁴ and R⁵ each independently represent one selected from the group consisting of a hydrogen atom, a halogen atom, an aryl group, an alkyl group, a cyano group, an acyl group, a carbamoyl group, an alkoxycarbonyl group, an aryloxycarbonyl group, an acyloxy group, an alkoxy group, an aryloxy group, an alkylthio group, an arylthio group, a sulfamoyl group, an alkylsulfonyl group, an arylsulfonyl group, an alkylphosphoryl group, an arylphosphoryl group, and an amino group; and R⁶ represents an alkyl group.

A third aspect of the invention is to provide the heat-sensitive recording material of the first aspect, wherein the coupler contains a compound represented by the following general formula (3):

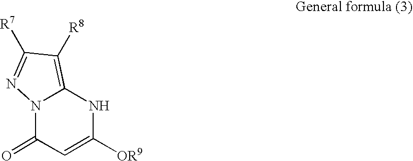

In general formula (3), R⁷ represents one selected from the group consisting of a hydrogen atom, an aryl group, an alkyl group, an alkoxy group, and an amino group; R⁸ represents one selected from the group consisting of a hydrogen atom, a halogen atom, an aryl group, an alkyl group, an alkoxy group, an aryloxy group, an alkylthio group, an arylthio group, and an amino group; and R⁹ represents an alkyl group.

A fourth aspect of the invention is to provide the heat-sensitive recording material of any one of the first to third aspects, wherein the diazonium salt contains a compound represented by the following general formula (4):

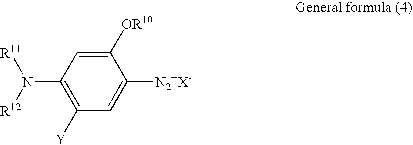

In general formula (4), R¹⁰, R¹¹ and R¹² each independently represent an alkyl group or an aryl group; Y represents a hydrogen atom, an alkoxy group, or an aryloxy group; and X⁻ represents an anion.

A fifth aspect of the invention is to provide the heat-sensitive recording material of any one of the first to third aspects, wherein the diazonium salt contains a compound represented by the following general formula (5):

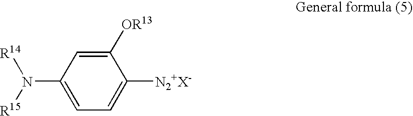

In general formula (5), R¹³, R¹⁴ and R¹⁵ each independently represent an alkyl group or an aryl group; and X⁻ represents an anion.

A sixth aspect of the invention is to provide the heat-sensitive recording material of any one of the first to fifth aspects, wherein the diazonium salt is encapsulated in microcapsules.

### DETAILED DESCRIPTION OF THE INVENTION

The present invention will be described in detail below.

The invention is to provide a heat-sensitive recording material comprising a support and a heat-sensitive recording layer formed on the support. The heat-sensitive recording layer contains a diazonium salt and a coupler that reacts with the diazonium salt to develop color. The coupler used in the invention is a compound represented by the following general formula (1):

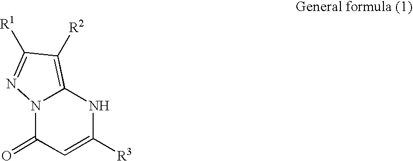

In the general formula (1), R¹ and R² each independently represent one selected from the group consisting of a hydrogen atom, a halogen atom, an aryl group, an alkyl group, a cyano group, an acyl group, a carbamoyl group, an alkoxycarbonyl group, an aryloxycarbonyl group, an acyloxy group, an alkoxy group, an aryloxy group, an alkylthio group, an arylthio group, a sulfamoyl group, an alkylsulfonyl group, an arylsulfonyl group, an alkylphosphoryl group, an arylphosphoryl group, and an amino group.

Among them, R¹ is preferably an aryl group having 6 to 30 carbon atoms or an electron donating group having a Hammett's substituent constant σₚ of −0.01 or less, and particularly preferably an aryl group having 6 to 25 carbon atoms or an electron donating group having a Hammett's substituent constant σₚ of −0.10 or less.

Preferred examples of the electron donating group having a Hammett's substituent constant σₚ of −0.01 or less include unsubstituted alkyl groups such as a methyl group having a Hammett's substituent constant σₚ of −0.17, alkoxy groups such as a methoxy group having a Hammett's substituent constant σₚ of −0.27, etc., and the electron donating group is not limited thereto.

Among electron attractive groups having a Hammett's substituent constant σₚ of 0.10 or more, preferred are perfluoroalkyl groups such as a trifluoromethyl group having a Hammett's substituent constant σₚ of 0.54, carbamoyl groups such as an N-methylcarbamoyl group having a Hammett's substituent constant σₚ of 0.36, alkoxycarbonyl groups such as a methoxycarbonyl group having a Hammett's substituent constant σₚ of 0.45, etc., and the electron attractive group is not limited thereto.

The halogen atom is preferably a fluorine atom, a chlorine atom, a bromine atom, etc., and more preferably a fluorine atom or a chlorine atom.

The aryl group represented by R¹ or R² may have a substituent of an alkyl group, an alkoxy group, an aryloxy group, a halogen atom, a nitro group, a cyano group, a carbamoyl group, a sulfamoyl group, an amino group, an alkylthio group, an arylthio group, an alkylsulfonyl group, an arylsulfonyl group, an aryl group, a hydroxy group, an acyl group, an acyloxy group, an aminocarbonyloxy group, a phosphoryloxy group or an alkoxycarbonyl group.

The aryl group preferably has 6 to 30 carbon atoms, and examples thereof include a phenyl group, a 2-methylphenyl group, a 2-chlorophenyl group, a 2-methoxyphenyl group, a 2-ethoxyphenyl group, a 2-propoxyphenyl group, a 2-isopropoxyphenyl group, a 2-butoxyphenyl group, a 2-(2-ethylhexyloxy)phenyl group, a 2-octyloxyphenyl group, a 2-undecyloxyphenyl group, a 2-trifluoromethylphenyl group, a 2-(2-ethylhexyloxy)-5-chlorophenyl group, 2-(2-ethylhexyloxy)-3,5-dichlorophenyl group, 3-(2,4-di-t-pentylphenoxyethoxy)phenyl group, a 2-(dibutylaminocarbonylethoxy)phenyl group, a 2,4-dichlorophenyl group, a 2,5-dichlorophenyl group, a 2,4,6-trimethylphenyl group, a 3-chlorophenyl group, a 3-nitrophenyl group, a 3-cyanophenyl group, a 3-trifluoromethylphenyl group, a 3-methoxyphenyl group, a 3-ethoxyphenyl group, a 3-butoxyphenyl group, a 3-(2-ethylhexyloxy)phenyl group, a 3,4-dichlorophenyl group, a 3,5-dichlorophenyl group, a 3,4-dimethoxyphenyl group, a 3,5-dibutoxyphenyl group, a 3-octyloxyphenyl group, a 3-(dibutylaminocarbonylmethoxy)phenyl group, a 3-(di-2-ethylhexylaminocarbonylmethoxy)phenyl group, a 3-dodecyloxyphenyl group, a 4-chlorophenyl group, a 4-cyanophenyl group, a 4-nitrophenyl group, a 4-trifluoromethylphenyl group, a 4-methoxyphenyl group, a 4-ethoxyphenyl group, a 4-isopropoxyphenyl group, a 4-butoxyphenyl group, a 4-(2-ethylhexyloxy)phenyl group, a 4-isopentyloxyphenyl group, a 4-(octadecyloxy)phenyl group, a 4-benzylphenyl group, a 4-aminosulfonylphenyl group, a 4-N,N-dibutylaminosulfonylphenyl group, a 4-ethoxycarbonylphenyl group, a 4-(2-ethylhexyloxycarbonyl)phenyl group, a 4-t-octylphenyl group, a 4-fluorophenyl group, a 3-acetylphenyl group, a 2-acetylaminophenyl group, a 2,4-di-t-pentylphenyl group, a 4-methylthiophenyl group, a 4-(4-chlorophenylthio)phenyl group, a hydroxyphenyl group, a phenylsulfonylphenyl group, a phenylcarbonyloxyphenyl group, a dimethylaminocarbonyloxyphenyl group, a butylcarbonyloxyphenyl group, etc.

The alkyl group represented by R¹ or R² may be normal or branched, and may have an unsaturated bond. Further, the alkyl group may have a substituent such as an alkoxy group, an aryloxy group, an alkoxycarbonyl group, an aryloxycarbonyl group, an aryl group, a hydroxy group and a halogen atom, and the aryl group may be further substituted by an alkyl group, an alkoxy group, a nitro group, a cyano group, a hydroxy group or a halogen atom.

The alkyl group represented by R¹ or R² preferably has 1 to 30 carbon atoms. Examples thereof include a methyl group, a trifluoromethyl group, an ethyl group, a butyl group, a hexyl group, an octyl group, a 2-ethylhexyl group, a decyl group, a dodecyl group, an octadecyl group, a propyl group, an isopropyl group, an isobutyl group, a sec-butyl group, a t-butyl group, a pentyl group, a 1-ethylpentyl group, a cyclopentyl group, a cyclohexyl group, an isopentyl group, a heptyl group, a nonyl group, an undecyl group, a propenyl group, a heptadecenyl group, a t-octyl group, an ethoxycarbonylmethyl group, a butoxycarbonylmethyl group, a 2-ethylhexyloxycarbonylmethyl group, a 1-(ethoxycarbonyl)ethyl group, a 2′,4′-diisopentylphenyloxymethyl group, a 2′,4′-di-t-butylphenyloxymethyl group, an ethoxycarbonylethyl group, a 2-ethylhexyloxycarbonylethyl group, a butyldecyloxycarbonylethyl group, a dibutylaminocarbonylmethyl group, a dibenzylaminocarbonylethyl group, an ethyloxycarbonylpropyl group, a 2-ethylhexyloxycarbonylpropyl group, a 2,4-di-t-amylphenyloxypropyl group, a 1-(2′,4′-di-t-amylphenyloxy)propyl group, a 2,4-di-t-butylphenyloxypropyl group, an acetylaminoethyl group, an N,N-dihexylaminocarbonylethyl group, a 2,4-di-t-amyloxyethyloxycarbonylpropyl group, an isostearyloxycarbonylpropyl group, a 1-(2,4-di-t-pentylphenyloxy)propyl group, a 2,4-di-t-pentylphenyloxyethyloxycarbonylpropyl group, a naphthyloxyethyloxycarbonylethyl group, an N-methyl-N-phenylaminoethyloxycarbonylethyl group, a methanesulfonylaminopropyl group, etc.

The acyl group represented by R¹ or R² preferably has 2 to 20 carbon atoms. Examples thereof include an acetyl group, a propanoyl group, a butanoyl group, a hexanoyl group, an octanoyl group, a 2-ethylhexanoyl group, a decanoyl group, a dodecanoyl group, an octadecanoyl group, a 2-cyanopropanoyl group, a 1,1-dimethylpropanoyl group, etc.

The carbamoyl group represented by R¹ or R² may have a substituent, and examples thereof include a carbamoyl group, N-alkylcarbamoyl groups, N-arylcarbamoyl groups, N,N-dialkylcarbamoyl groups, N,N-diarylcarbamoyl groups, N-alkyl-N-arylcarbamoyl groups, etc.

The carbamoyl group with a substituent is preferably has 2 to 30 carbon atoms. Examples thereof include an N-methylcarbamoyl group, an N-ethylcarbamoyl group, an N-propylcarbamoyl group, an N-butylcarbamoyl group, an N-hexylcarbamoyl group, an N-cyclohexylcarbamoyl group, an N-octylcarbamoyl group, an N-(2-ethylhexyl)carbamoyl group, an N-decylcarbamoyl group, an N-octadecylcarbamoyl group, an N-phenylcarbamoyl group, an N-(2-methylphenyl)carbamoyl group, an N-(2-chlorophenyl)carbamoyl group, an N-(2-methoxyphenyl)carbamoyl group, an N-(2-isopropoxyphenyl)carbamoyl group, an N-(2-(2-ethylhexyloxy)phenyl)carbamoyl group, an N-(3-chlorophenyl)carbamoyl group, an N-(3-nitrophenyl)carbamoyl group, an N-(3-cyanophenyl)carbamoyl group, an N-(4-methoxyphenyl)carbamoyl group, an N-(4-(2-ethylhexyloxy)phenyl)carbamoyl group, an N-(4-cyanophenyl)carbamoyl group, an N-methyl-N-phenylcarbamoyl group, an N,N-dimethylcarbamoyl group, an N,N-dibutylcarbamoyl group, an N,N-diphenylcarbamoyl group, an N-toluenesulfonylcarbamoyl group, an N-hexylsulfonylcarbamoyl group, etc.

The alkoxycarbonyl group represented by R¹ or R² preferably has 2 to 20 carbon atoms. Examples thereof include a methoxycarbonyl group, an ethoxycarbonyl group, a propoxycarbonyl group, a butoxycarbonyl group, a hexyloxycarbonyl group, a 2-ethylhexyloxycarbonyl group, an octyloxycarbonyl group, a decyloxycarbonyl group, an octadecyloxycarbonyl group, a phenyloxyethyloxycarbonyl group, a phenyloxypropyloxycarbonyl group, a 2,4-di-t-amylphenyloxyethylcarbonyl group, a 2,6-di-t-butyl-4-methylcyclohexyloxycarbonyl group, an isostearyloxycarbonyl group, etc.

The aryloxycarbonyl group represented by R¹ or R² preferably has 7 to 30 carbon atoms. Examples thereof include a 2-methylphenyloxycarbonyl group, a 2-chlorophenyloxycarbonyl group, a 2,6-dimethylphenyloxycarbonyl group, a 2,4,6-trimethylphenyloxycarbonyl group, a 2-methoxyphenyloxycarbonyl group, a 2-butoxyphenyloxycarbonyl group, a 3-cyanophenyloxycarbonyl group, a 3-nitrophenyloxycarbonyl group, a 2-(2-ethylhexyl)phenyloxycarbonyl group, a 3-(2-ethylhexyloxy)phenyloxycarbonyl group, a 4-fluorophenyloxycarbonyl group, a 4-chlorophenyloxycarbonyl group, a 4-cyanophenyloxycarbonyl group, a 4-butoxyphenyloxycarbonyl group, etc.

The acyloxy group represented by R¹ or R² preferably has 2 to 20 carbon atoms. Examples thereof include an acetyloxy group, a propanoyloxy group, a butanoyloxy group, a pentanoyloxy group, a trifluoromethylcarbonyloxy group, an octanoyloxy group, a decanoyloxy group, an undecanoyloxy group, an octadecanoyloxy group, etc.

The alkoxy group represented by R¹ or R² preferably has 1 to 30 carbon atoms. Examples thereof include a methoxy group, an ethoxy group, a propyloxy group, an isopropyloxy group, a butoxy group, an isobutoxy group, a sec-butoxy group, a t-butoxy group, a pentyloxy group, an isopentyloxy group, a hexyloxy group, a heptyloxy group, an octyloxy group, a 2-ethylhexyloxy group, a decyloxy group, a dodecyloxy group, an octadecyloxy group, an ethoxycarbonylmethyloxy group, a 2-ethylhexyloxycarbonylmethyloxy group, an aminocarbonylmethyloxy group, an N,N-dibutylaminocarbonylmethyloxy group, an N-methylaminocarbonylmethyloxy group, an N-ethylaminocarbonylmethyloxy group, an N-octylaminocarbonylmethyloxy group, an N-methyl-N-benzylaminocarbonylmethyloxy group, a benzyloxy group, a cyanomethyloxy group, etc.

The aryloxy group represented by R¹ or R² preferably has 6 to 30 carbon atoms. Examples thereof include a phenyloxy group, a 1-naphthyloxy group, a 2-naphthyloxy group, a 2-chlorophenyloxy group, a 2-methylphenyloxy group, a 2-methoxyphenyloxy group, a 2-butoxyphenyloxy group, a 3-chlorophenyloxy group, a 3-trifluoromethylphenyloxy group, a 3-cyanophenyloxy group, a 3-(2-ethylhexyloxy)phenyloxy group, a 3-nitrophenyloxy group, a 4-fluorophenyloxy group, a 4-cyanophenyloxy group, a 4-butoxyphenyloxy group, a 4-(2-ethylhexyloxy)phenyloxy group, a 4-octadecylphenyloxy group, etc.

The alkylthio group represented by R¹ or R² preferably has 1 to 30 carbon atoms. Examples thereof include a methylthio group, an ethylthio group, a propylthio group, an isopropylthio group, a butylthio group, an isobutylthio group, a sec-butylthio group, a t-butylthio group, a pentylthio group, an isopentylthio group, a hexylthio group, a heptylthio group, an octylthio group, a 2-ethylhexylthio group, a decylthio group, a dodecylthio group, an octadecylthio group, an ethoxycarbonylmethylthio group, a 2-ethylhexyloxycarbonylmethylthio group, an aminocarbonylmethylthio group, an N,N-dibutylaminocarbonylmethylthio group, an N-methylaminocarbonylmethylthio group, an N-ethylaminocarbonylmethylthio group, an N-octylaminocarbonylmethylthio group, an N-methyl-N-benzylaminocarbonylmethylthio group, a benzylthio group, a cyanomethylthio group, etc.

The arylthio group represented by R¹ or R² preferably has 6 to 30 carbon atoms. Examples thereof include a phenylthio group, a 1-naphthylthio group, a 2-naphthylthio group, a 2-chlorophenylthio group, a 2-methylphenylthio group, a 2-methoxyphenylthio group, a 2-butoxyphenylthio group, a 3-chlorophenylthio group, a 3-trifluoromethylphenylthio group, a 3-cyanophenylthio group, a 3-(2-ethylhexyloxy)phenylthio group, a 3-nitrophenylthio group, a 4-fluorophenylthio group, a 4-cyanophenylthio group, a 4-butoxyphenylthio group, a 4-(2-ethylhexyloxy)phenylthio group, a 4-octadecylphenylthio group, etc.

The sulfamoyl group represented by R¹ or R² may have a substituent, and examples thereof include a sulfamoyl group, N-alkylsulfamoyl groups, N-arylsulfamoyl groups, N,N-dialkylsulfamoyl groups, N,N-diarylsulfamoyl groups, and N-alkyl-N-arylsulfamoyl groups.

The sulfamoyl group with a substituent represented by R¹ or R² preferably has 1 to 30 carbon atoms. Examples thereof include an N-methylsulfamoyl group, an N-ethylsulfamoyl group, an N-propylsulfamoyl group, an N-butylsulfamoyl group, an N-hexylsulfamoyl group, an N-cyclohexylsulfamoyl group, an N-octylsulfamoyl group, an N-(2-ethylhexyl)sulfamoyl group, an N-decylsulfamoyl group, an N-octadecylsulfamoyl group, an N-phenylsulfamoyl group, an N-(2-methylphenyl)sulfamoyl group, an N-(2-chlorophenyl)sulfamoyl group, an N-(2-methoxyphenyl)sulfamoyl group, an N-(2-isopropoxyphenyl)sulfamoyl group, an N-(2-(2-ethylhexyloxy)phenyl) sulfamoyl group, an N-(3-chlorophenyl) sulfamoyl group, an N-(3-nitrophenyl)sulfamoyl group, an N-(3-cyanophenyl)sulfamoyl group, an N-(4-methoxyphenyl)sulfamoyl group, an N-(4-(2-ethylhexyloxy)phenyl)sulfamoyl group, an N-(4-cyanophenyl)sulfamoyl group, an N-methyl-N-phenylsulfamoyl group, an N,N-dimethylsulfamoyl group, an N,N-dibutylsulfamoyl group, an N,N-diphenylsulfamoyl group, an N,N-di(2-ethylhexyl)sulfamoyl group, etc.

The alkylsulfonyl group represented by R¹ or R² preferably has 1 to 20 carbon atoms. Examples thereof include a methylsulfonyl group, an ethylsulfonyl group, a propylsulfonyl group, an isopropylsulfonyl group, a butylsulfonyl group, a hexylsulfonyl group, a cyclohexylsulfonyl group, an octylsulfonyl group, a 2-ethylhexylsulfonyl group, a decylsulfonyl group, a dodecylsulfonyl group, an octadecylsulfonyl group, a cyanomethylsulfonyl group, etc.

The arylsulfonyl group represented by R¹ or R² preferably has 6 to 30 carbon atoms. Examples thereof include a phenylsulfonyl group, a 1-naphthylsulfonyl group, a 2-naphthylsulfonyl group, a 2-chlorophenylsulfonyl group, a 2-methylphenylsulfonyl group, a 2-methoxyphenylsulfonyl group, a 2-butoxyphenylsulfonyl group, a 3-chlorophenylsulfonyl group, a 3-trifluoromethylphenylsulfonyl group, a 3-cyanophenylsulfonyl group, a 3-(2-ethylhexyloxy)phenylsulfonyl group, a 3-nitrophenylsulfonyl group, a 4-fluorophenylsulfonyl group, a 4-cyanophenylsulfonyl group, a 4-butoxyphenylsulfonyl group, a 4-(2-ethylhexyloxy)phenylsulfonyl group, a 4-octadecylphenylsulfonyl group, etc.

The alkylphosphoryl group represented by R¹ or R² preferably has 2 to 40 carbon atoms. Examples thereof include a methylphosphoryl group, an ethylphosphoryl group, a propylphosphoryl group, an isopropylphosphoryl group, a butylphosphoryl group, an isobutylphosphoryl group, a sec-butylphosphoryl group, a t-butylphosphoryl group, a pentylphosphoryl group, an isopentylphosphoryl group, a hexylphosphoryl group, a heptylphosphoryl group, an octylphosphoryl group, a 2-ethylhexylphosphoryl group, a decylphosphoryl group, a dodecylphosphoryl group, an octadecylphosphoryl group, an ethoxycarbonylmethylphosphoryl group, a 2-ethylhexyloxycarbonylmethylphosphoryl group, an aminocarbonylmethylphosphoryl group, an N,N-dibutylaminocarbonylmethylphosphoryl group, an N-methylaminocarbonylmethylphosphoryl group, an N-ethylaminocarbonylmethylphosphoryl group, an N-octylaminocarbonylmethylphosphoryl group, a benzylphosphoryl group, etc.

The arylphosphoryl group represented by R¹ or R² preferably has 12 to 50 carbon atoms. Examples thereof include a phenylphosphoryl group, a 1-naphthylphosphoryl group, a 2-naphthylphosphoryl group, a 2-chlorophenylphosphoryl group, a 2-methylphenylphosphoryl group, a 2-methoxyphenylphosphoryl group, a 2-butoxyphenylphosphoryl group, a 3-chlorophenylphosphoryl group, a 3-trifluoromethylphenylphosphoryl group, a 3-cyanophenylphosphoryl group, a 3-(2-ethylhexyloxy)phenylphosphoryl group, a 3-nitrophenylphosphoryl group, a 4-fluorophenylphosphoryl group, a 4-cyanophenylphosphoryl group, a 4-butoxyphenylphosphoryl group, a 4-(2-ethylhexyloxy)phenylphosphoryl group, a 4-octadecylphenylphosphoryl group, etc.

The amino group represented by R¹ or R² may have a substituent, and examples thereof include an amino group, N-alkylamino groups, N-arylamino groups, N-acylamino groups, N-sulfonylamino groups, N,N-dialkylamino groups, N,N-diarylamino groups, N-alkyl-N-arylamino groups, N,N-disulfonylamino groups, etc.

The amino group with a substituent preferably has 1 to 50 carbon atoms. Examples thereof include an N-methylamino group, an N-ethylamino group, an N-propylamino group, an N-isopropylamino group, an N-tert-butylamino group, an N-hexylamino group, an N-cyclohexylamino group, an N-octylamino group, an N-(2-ethylhexyl)amino group, an N-decylamino group, an N-octadecylamino group, an N-benzylamino group, an N-phenylamino group, an N-(2-methylphenyl)amino group, an N-(2-chlorophenyl)amino group, an N-(2-methoxyphenyl)amino group, an N-(2-isopropoxyphenyl)amino group, an N-(2-(2-ethylhexyloxy)phenyl)amino group, an N-(3-chlorophenyl)amino group, an N-(3-nitrophenyl)amino group, an N-(3-cyanophenyl)amino group, an N-(4-methoxyphenyl)amino group, an N-(4-(2-ethylhexyloxy)phenyl)amino group, an N-(4-cyanophenyl)amino group, an N-methyl-N-phenylamino group, an N,N-dimethylamino group, an N,N-dibutylamino group, an N,N-diphenylamino group, an N,N-diacetylamino group, an N,N-dibenzoylamino group, an N,N-di(butylcarbonyl)amino group, an N,N-di(2-ethylhexylcarbonyl)amino group, an N,N-di(methylsulfonyl)amino group, an N,N-di(ethylsulfonyl)amino group, an N,N-di(butylsulfonyl)amino group, an N,N-di(2-ethylhexylsulfonyl)amino group, an N,N-di(phenylsulfonyl)amino group, an N-acetylamino group, an N-pivaloylamino group, an N-(2-ethylhexanoyl)amino group, an N-benzoylamino group, an N-hexyloxycarbonylamino group, an N-methylsulfonylamino group, an N-phenylsulfonylamino group, etc.

In the general formula (1), R³ represents an alkoxy group, an aryloxy group or an alkylamino group. Examples of the alkoxy group and the aryloxy group represented by R³ may be the same as those of the above-mentioned R¹ and R². The alkylamino group is such that derived by substituting 1 or 2 hydrogen atom of an amino group with an alkyl group or a substituted alkyl group, and examples thereof include an N-methylamino group, an N-ethylamino group, an N-propylamino group, an N-isopropylamino group, an N-tert-butylamino group, an N-hexylamino group, an N-cyclohexylamino group, an N-octylamino group, an N-(2-ethylhexyl)amino group, an N-decylamino group, an N-octadecylamino group, an N-benzylamino group, an N,N-dimethylamino group, an N,N-dibutylamino group, an N,N-(2-ethylhexyl)amino group, an N-methyl-N-octadecylamino group, etc. In the case where 2 hydrogen atoms of an amino group are substituted by an alkyl group or a substituted alkyl group, 2 substituents may form a ring. Further, 1 or more carbon atom of the formed ring may be substituted by an oxygen atom, etc.

The coupler used in the invention preferably contains a compound represented by the following general formula (2):

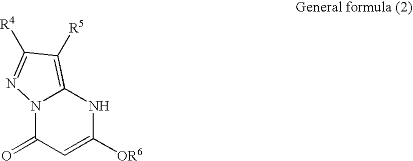

In the general formula (2), R⁴ and R⁵ each independently represent a hydrogen atom, a halogen atom, an aryl group, an alkyl group, a cyano group, an acyl group, a carbamoyl group, an alkoxycarbonyl group, an aryloxycarbonyl group, an acyloxy group, an alkoxy group, an aryloxy group, an alkylthio group, an arylthio group, a sulfamoyl group, an alkylsulfonyl group, an arylsulfonyl group, an alkylphosphoryl group, an arylphosphoryl group or an amino group, and R⁶ represents an alkyl group. Examples of the atom and groups are the same as those provided for the general formula (1).

The coupler used in the invention more preferably contains a compound represented by the following general formula (3):

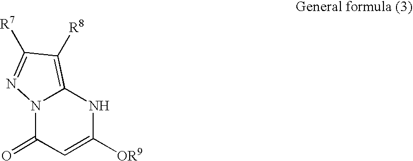

In the general formula (3), R⁷ represents a hydrogen atom, an aryl group, an alkyl group, an alkoxy group or an amino group, R⁸ represents a hydrogen atom, a halogen atom, an aryl group, an alkyl group, an alkoxy group, an aryloxy group, an alkylthio group, an arylthio group or an amino group, and R⁹ represents an alkyl group. Examples of the atom and groups are the same as those provided for the general formula (1).

Specific examples of the compound represented by the general formula (1), which is used as the coupler in the invention, are illustrated below, but they should not be construed to limit the scope of the invention.

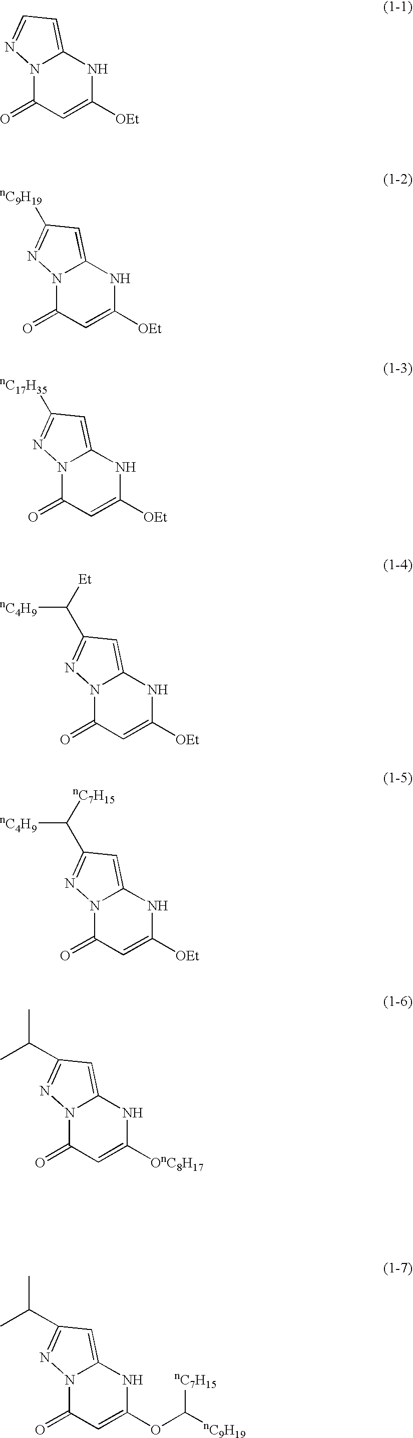

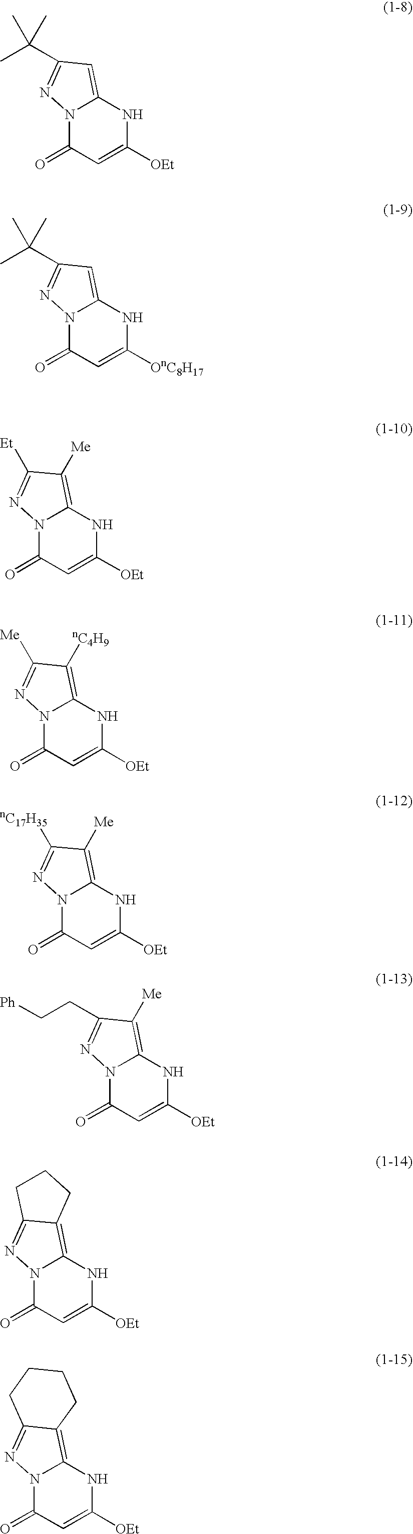

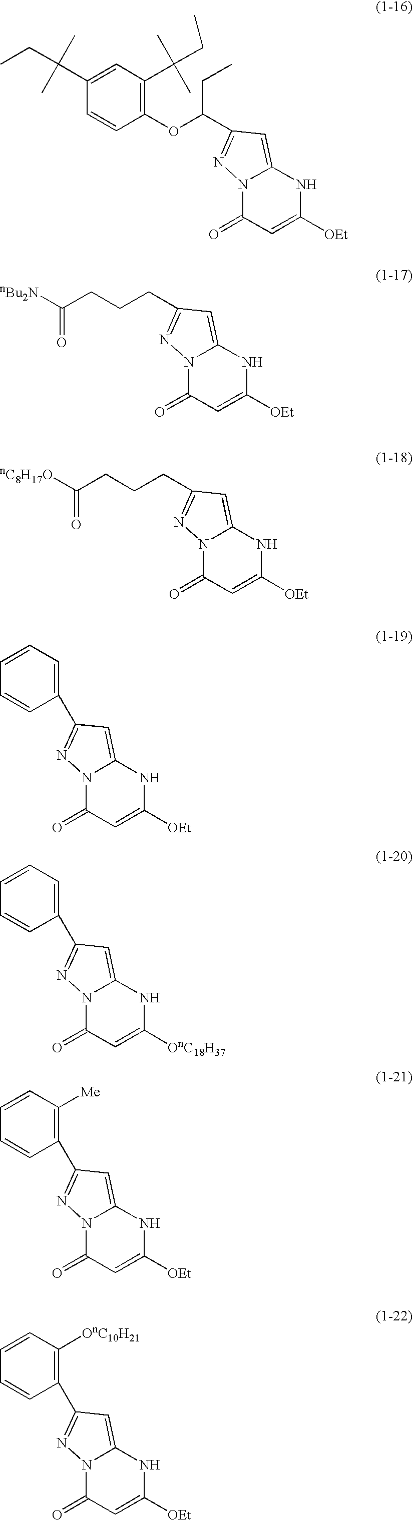

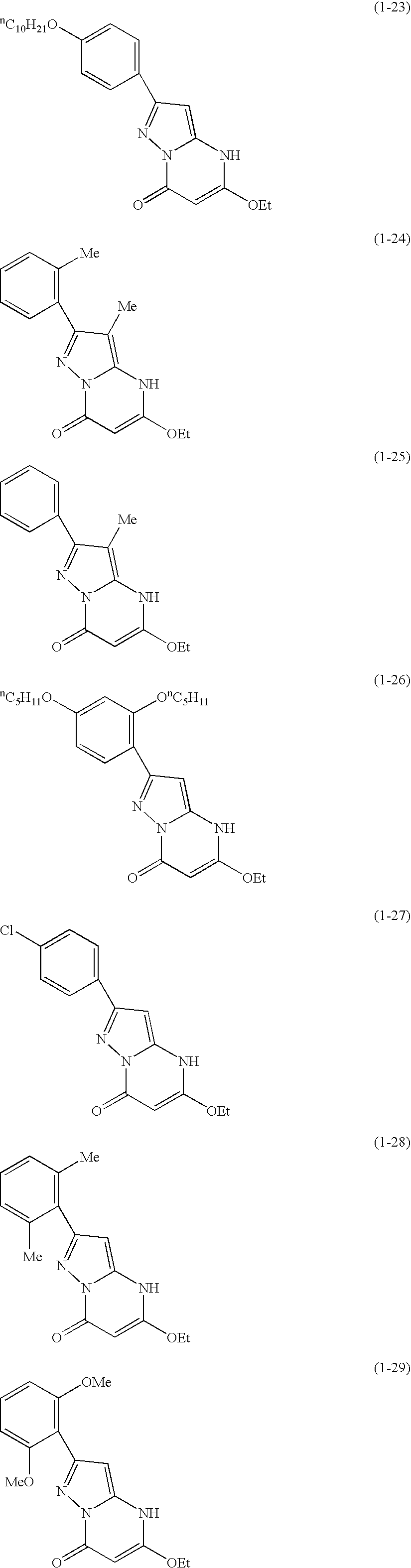

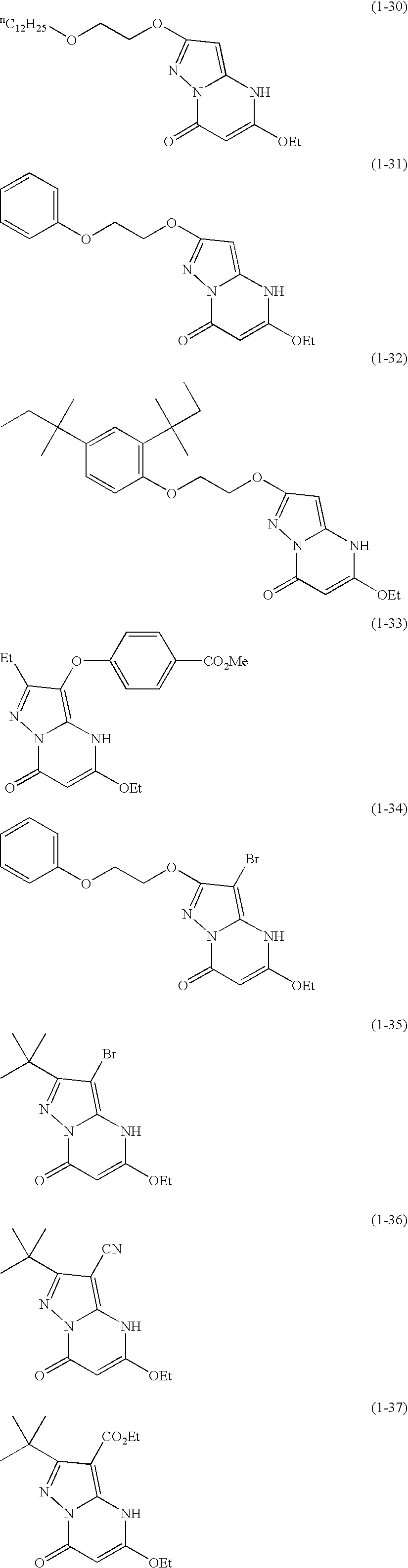

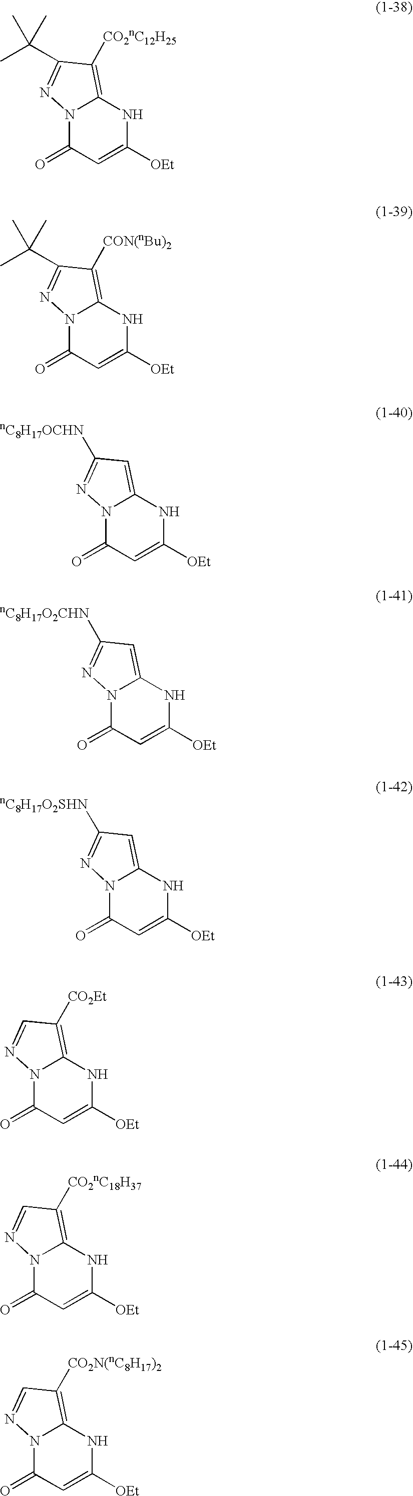

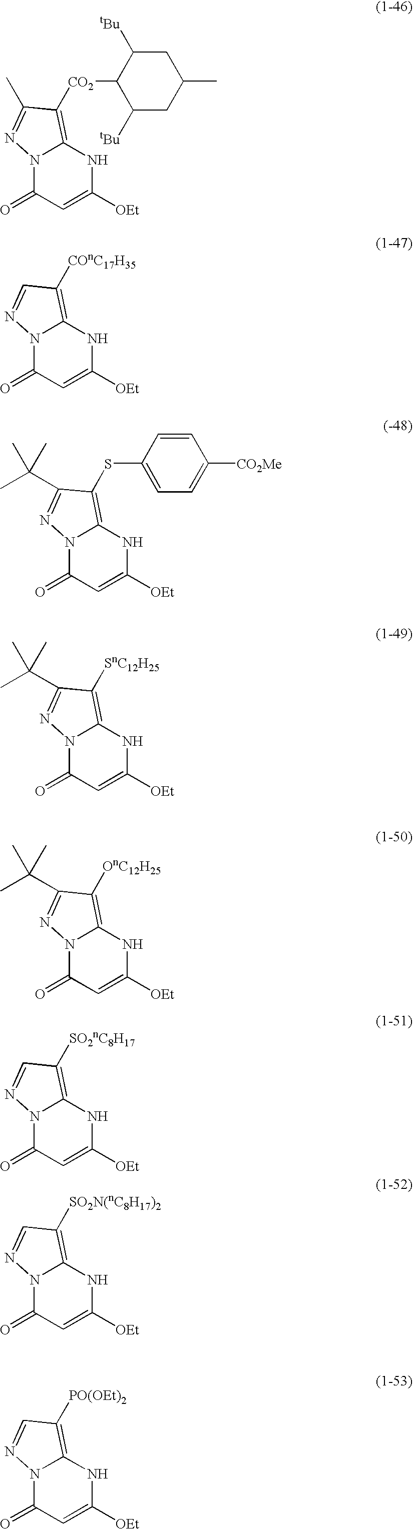

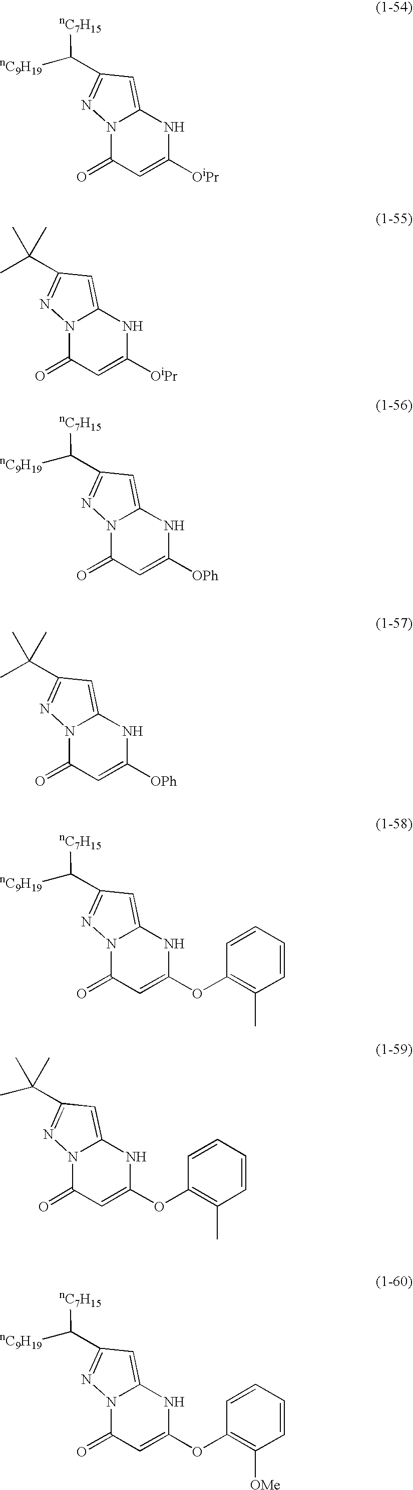

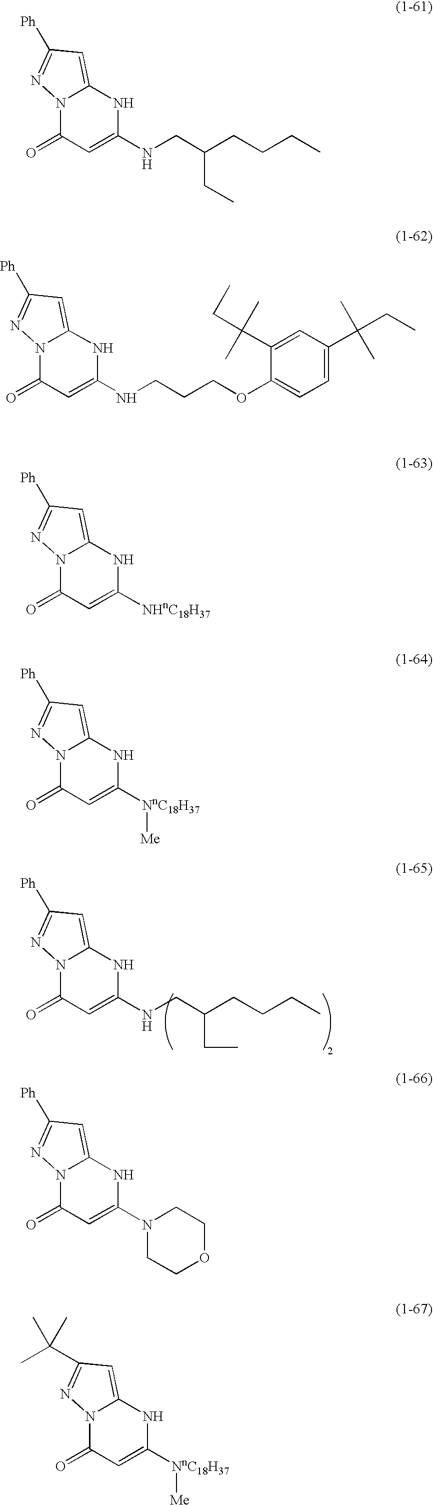

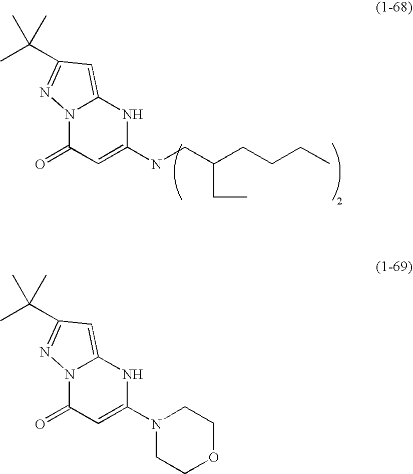

The compound represented by the general formula (1) may be used singly, and a plurality of the compounds may be used in combination.

The coupler used in the invention is coupled with a diazo compound in basic atmosphere and/or neutral atmosphere to form a dye. The coupler may be used with a known coupler for a purpose of color control, etc. The known coupler may be a so-called active methylene compound having a methylene group adjacent to a carbonyl group, a phenol derivative, a naphthol derivative, etc. The following ones are provided as specific examples of the known coupler, which is used within the scope of the invention.

Particularly preferred examples of the known coupler for use in the invention include resorcin, phloroglucin, 2,3-dihydroxynaphthalene, sodium 2,3-dihydroxynaphthalene-6-sulfonate, 1-hydroxy-2-naphthoic acid morpholinopropylamide, sodium 2-hydroxy-3-naphthalenesulfonate, 2-hydroxy-3-naphthalenesulfonanilide, 2-hydroxy-3-naphthalenesulfonic acid morpholinopropylamide, 2-hydroxy-3-naphthalenesulfonic acid-2-ethylhexyloxypropylamide, 2-hydroxy-3-naphthalenesulfonic acid-2-ethylhexylamide, 5-acetamido-1-naphthol, sodium 1-hydroxy-8-acetamidonaphthalene-3,6-disulfonate, 1-hydroxy-8-acetamidonaphthalene-3,6-disulfonic acid dianilide, 1,5-dihydroxynaphthalene, 2-hydroxy-3-naphthoic acid morpholinopropylamide, 2-hydroxy-3-naphthoic acid octylamide, 2-hydroxy-3-naphthoic acid anilide, 5,5-dimethyl-1,3-cyclohexanedione, 1,3-cyclopentanedione, 5-(2-n-tetradecyloxyphenyl)-1,3-cyclohexanedione, 5-phenyl-4-methoxycarbonyl-1,3-cyclohexanedione, 5-(2,5-di-n-octyloxyphenyl)-1,3-cyclohexanedione, N,N′-dicyclohexylbarbituric acid, N,N′-di-n-dodecylbarbituric acid, N-n-octyl-N′-n-octadecylbarbituric acid, N-phenyl-N′-(2,5-di-n-octyloxyphenyl)barbituric acid, N,N′-bis(octadecyloxycarbonylmethyl)barbituric acid, 1-phenyl-3-methyl-5-pyrazolone, 1-(2,4,6-trichlorophenyl)-3-anilino-5-pyrazolone, 1-(2,4,6-trichlorophenyl)-3-benzamido-5-pyrazolone, 6-hydroxy-4-methyl-3-cyano-1-(2-ethylhexyl)-2-pyridone, 2,4-bis(benzoylacetamido)toluene, 1,3-bis(pivaloylacetamidomethyl)benzene, benzoylacetonitrile, thenoylacetonitrile, acetoacetanilide, benzoylacetanilide, pivaloylacetanilide, 2-chloro-5-(N-n-butylsulfamoyl)-1-pivaloylacetamidobenzene, 1-(2-ethylhexyloxypropyl)-3-cyano-4-methyl-6-hydroxy-1,2-dihydropyridine-2-one, 1-(dodecyloxypropyl)-3-acetyl-4-methyl-6-hydroxy-1,2-dihydropyridine-2-one, 1-(4-n-octyloxyphenyl)-3-tert-butyl-5-aminopyrazole, etc.

The known couplers are described in detail in JP-A Nos. 4-201483, 7-223367, 7-223368, 7-323660, 7-125446, 7-096671, 7-223367, 7-223368, 9-156229, 9-216468, 9-216469, 9-319025, 10-035113, 10-193801, 10-264532, etc.

The amount of the coupler in the heat-sensitive recording layer may be 0.02 to 5 g/m², and preferably 0.1 to 4 g/m² from the viewpoint of the effects. The amount less than 0.02 g/m² is not preferred from the viewpoint of color-developing properties, and the amount more than 5 g/m² is not preferred from the viewpoint of coating properties.

The diazonium salt used in the invention is a compound represented by the following general formula:

Ar—N₂⁺X⁻

In the above general formula, Ar represents an aromatic moiety, and X⁻ represents an anion. The diazonium salt induces a coupling reaction with the coupler by heating to develop color, and is decomposed by a light. The maximum absorption wavelength of the diazonium salt can be controlled by selecting a kind or a position of a substituent on the aromatic moiety.

Specific examples of diazonium forming the diazonium salt include 4-(p-tolylthio)-2,5-dibutoxybenzenediazonium, 4-(4-chlorophenylthio)-2,5-dibutoxybenzenediazonium, 4-(N,N-dimethylamino)benzenediazonium, 4-(N,N-diethylamino)benzenediazonium, 4-(N,N-dipropylamino)benzenediazonium, 4-(N-methyl-N-benzylamino)benzenediazonium, 4-(N,N-dibenzylamino)benzenediazonium, 4-(N-ethyl-N-hydroxyethylamino)benzenediazonium, 4-(N,N-diethylamino)-3-methoxybenzenediazonium, 4-(N,N-dimethylamino)-2-methoxybenzenediazonium, 4-(N-benzoylamino)-2,5-diethoxybenzenediazonium, 4-morpholino-2,5-dibutoxybenzenediazonium, 4-anilinobenzenediazonium, 4-[N-(4-methoxybenzoyl)amino]-2,5-diethoxybenzenediazonium, 4-pyrrolidino-3-ethylbenzenediazonium, 4-[N-(1-methyl-2-(4-methoxyphenoxy)ethyl)-N-hexylamino]-2-hexyloxybenzenediazonium, 4-[N-(2-(4-methoxyphenoxy)ethyl)-N-hexylamino]-2-hexyloxybenzenediazonium, 2-(1-ethylpropyloxy)-4-[di-(di-n-butylaminocarbonylmethyl)amino]benzenediazonium, etc.

The maximum absorption wavelength λₘₐₓ of the diazonium salt used for the invention is preferably 450 nm or less, and particularly preferably 290 to 440 nm, from the viewpoint of the effects. The wavelength λₘₐₓ of the diazonium salt exceeding the above range is not preferred from the viewpoint of the stability. The wavelength λₘₐₓ of the diazonium salt smaller than the above range is not preferred from the viewpoints of the image-fixing property, the image shelf life and the magenta color tone in combination with the coupler.

It is desirable that the diazonium salt used in the invention has 12 or more carbon atoms, and that it has solubility in water of 1% or less, and solubility in ethyl acetate of 5% or more.

The diazonium salts represented by the following general formula (4) or (5) are particularly preferably used in the invention from the viewpoints of the color tone of the dye, the image shelf life and the image-fixing property.

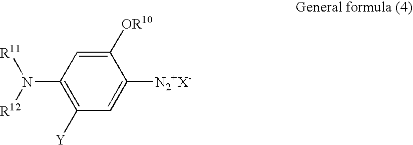

In the general formula (4), R¹⁰, R¹¹ and R¹² each independently represent an alkyl group or an aryl group, Y represents a hydrogen atom, an alkoxy group or an aryloxy group, and X⁻ represents an anion. The alkyl group and the aryl group may have a substituent. R¹⁰, R¹¹ and R¹² may be the same or different groups. The substituent may be an alkyl group, an alkoxy group, an alkylthio group, an aryl group, an aryloxy group, an arylthio group, an acyl group, an alkoxycarbonyl group, a carbamoyl group, a carbamide group, a sulfonyl group, a sulfamoyl group, a sulfonamide group, an ureido group, a halogen atom, an amino group, a heterocyclic group, etc.

The alkyl group represented by R¹⁰, R¹¹ or R¹² preferably has 1 to 18 carbon atoms. Preferred examples thereof include a methyl group, a trifluoromethyl group, an ethyl group, a propyl group, an isopropyl group, a butyl group, a sec-butyl group, a t-butyl group, a pentyl group, an isopentyl group, a cyclopentyl group, a hexyl group, a cyclohexyl group, an octyl group, a t-octyl group, a 2-ethylhexyl group, a nonyl group, an octadecyl group, a benzyl group, a 4-methoxybenzyl group, a triphenylmethyl group, an ethoxycarbonylmethyl group, a butoxycarbonylmethyl group, a 2-ethylhexyloxycarbonylmethyl group, a 2′,4′-diisopentylphenyloxymethyl group, a 2′,4′-di-t-butylphenyloxymethyl group, a dibenzylaminocarbonylmethyl group, a 2,4-di-t-amylphenyloxypropyl group, an ethoxycarbonylpropyl group, a 1-(2′,4′-di-t-amylphenyloxy)propyl group, an acetylaminoethyl group, a 2-(N,N-dimethylamino)ethyl group, a 2-(N,N-diethylamino)propyl group, a methanesulfonylaminopropyl group, an acetylaminoethyl group, a 2-(N,N-dimethylamino)ethyl group, a 2-(N,N-diethylamino)propyl group, a 1-methyl-2-(4-methoxyphenoxy)ethyl group, a di-n-butylaminocarbonylmethyl group, a di-n-octylaminocarbonylmethyl group, etc.

The aryl group represented by R¹⁰, R¹¹ or R¹² preferably has 6 to 30 carbon atoms. Examples thereof include a phenyl group, a 2-methylphenyl group, a 2-chlorophenyl group, a 2-methoxyphenyl group, a 2-butoxyphenyl group, a 2-(2-ethylhexyloxy)phenyl group, a 2-octyloxyphenyl group, a 3-(2,4-di-t-pentylphenoxyethoxy)phenyl group, a 4-chlorophenyl group, a 2,5-dichlorophenyl group, a 2,4,6-trimethylphenyl group, a 3-chlorophenyl group, a 3-methylphenyl group, a 3-methoxyphenyl group, a 3-butoxyphenyl group, a 3-cyanophenyl group, a 3-(2-ethylhexyloxy)phenyl group, a 3,4-dichlorophenyl group, a 3,5-dichlorophenyl group, a 3,4-dimethoxyphenyl group, a 3-(dibutylaminocarbonylmethoxy)phenyl group, a 4-cyanophenyl group, a 4-methylphenyl group, a 4-methoxyphenyl group, a 4-butoxyphenyl group, a 4-(2-ethylhexyloxy)phenyl group, a 4-benzylphenyl group, a 4-aminosulphonylphenyl group, a 4-N,N-dibutylaminosulfonylphenyl group, a 4-ethoxycarbonylphenyl group, a 4-(2-ethylhexylcarbonyl)phenyl group, a 4-fluorophenyl group, a 3-acetylphenyl group, a 2-acetylaminophenyl group, a 4-(4-chlorophenylthio)phenyl group, a 4-(4-methylphenyl)thio-2,5-butoxyphenyl group, a 4-(N-benzyl-N-methylamino)-2-dodecyloxycarbonylphenyl group, etc. The aryl group is not particularly limited to the examples, and may further substituted by an alkyloxy group, an alkylthio group, a substituted phenyl group, a cyano group, a substituted amino group, a halogen atom, a heterocyclic group, etc.

Y represents a hydrogen atom, an alkoxy group or an aryloxy group. The alkoxy group and the aryloxy group are represented by the formula —OR¹⁶. In the formula —OR¹⁶, R¹⁶ represents a substituted or unsubstituted alkyl group, or a substituted or unsubstituted aryl group, and the substituent thereon may be an alkyl group, an alkoxy group, an alkylthio group, an aryl group, an aryloxy group, an arylthio group, an acyl group, an alkoxycarbonyl group, a carbamoyl group, a carbamide group, a sulfonyl group, a sulfamoyl group, a sulfonamide group, an ureido group, a halogen atom, an amino group, a heterocyclic group, etc. From the viewpoint of the color tone control, Y is preferably a hydrogen atom or an alkyloxy group with R¹⁶ being an alkyl group.

The alkyl group represented by R¹⁶ preferably has 1 to 18 carbon atoms. Preferred examples thereof include a methyl group, a trifluoromethyl group, an ethyl group, a propyl group, an isopropyl group, a butyl group, a sec-butyl group, a t-butyl group, a pentyl group, an isopentyl group, a cyclopentyl group, a hexyl group, a cyclohexyl group, an octyl group, a t-octyl group, a 2-ethylhexyl group, a nonyl group, an octadecyl group, a benzyl group, a 4-methoxybenzyl group, a triphenylmethyl group, an ethoxycarbonylmethyl group, a butoxycarbonylmethyl group, a 2-ethylhexyloxycarbonylmethyl group, a 2′,4′-diisopentylphenyloxymethyl group, a 2′,4′-di-t-butylphenyloxymethyl group, a dibenzylaminocarbonylmethyl group, a 2,4-di-t-amylphenyloxypropyl group, an ethoxycarbonylpropyl group, a 1-(2′,4′-di-t-amylphenyloxy)propyl group, an acetylaminoethyl group, a 2-(N,N-dimethylamino)ethyl group, a 2-(N,N-diethylamino)propyl group, a methanesulfonylaminopropyl group, an acetylaminoethyl group, a 2-(N,N-dimethylamino)ethyl group, a 2-(N,N-diethylamino)propyl group, etc.

The aryl group represented by R¹⁶ preferably has 6 to 30 carbon atoms. Examples thereof include a phenyl group, a 2-methylphenyl group, a 2-chlorophenyl group, a 2-methoxyphenyl group, a 2-butoxyphenyl group, a 2-(2-ethylhexyloxy)phenyl group, a 2-octyloxyphenyl group, a 3-(2,4-di-t-pentylphenoxyethoxy)phenyl group, a 4-chlorophenyl group, a 2,5-dichlorophenyl group, a 2,4,6-trimethylphenyl group, a 3-chlorophenyl group, a 3-methylphenyl group, a 3-methoxyphenyl group, a 3-butoxyphenyl group, a 3-cyanophenyl group, a 3-(2-ethylhexyloxy)phenyl group, a 3,4-dichlorophenyl group, a 3,5-dichlorophenyl group, a 3,4-dimethoxyphenyl group, a 3-(dibutylaminocarbonylmethoxy)phenyl group, a 4-cyanophenyl group, a 4-methylphenyl group, a 4-methoxyphenyl group, a 4-butoxyphenyl group, a 4-(2-ethylhexyloxy)phenyl group, a 4-benzylphenyl group, a 4-aminosulfonylphenyl group, a 4-N,N-dibutylaminosulfonylphenyl group, a 4-ethoxycarbonylphenyl group, a 4-(2-ethylhexylcarbonyl)phenyl group, a 4-fluorophenyl group, a 3-acetylphenyl group, a 2-acetylaminophenyl group, a 4-(4-chlorophenylthio)phenyl group, a 4-(4-methylphenyl)thio-2,5-butoxyphenyl group, a 4-(N-benzyl-N-methylamino)-2-dodecyloxycarbonylphenyl group, etc. The aryl group is not particularly limited to the examples, and may further substituted by an alkyloxy group, an alkylthio group, a substituted phenyl group, a cyano group, a substituted amino group, a halogen atom, a heterocyclic group, etc.

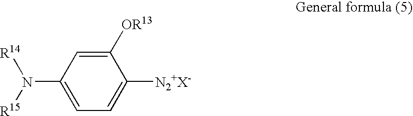

In the general formula (5), R¹³, R¹⁴ and R¹⁵ each independently represent an alkyl group or an aryl group, and X⁻ represents an anion. The alkyl group and the aryl group are the same as those represented by R¹⁰, R¹¹ and R¹² in the general formula (4) with respect to meanings and embodiments.

In the general formulae (4) and (5), X⁻ represents an anion with examples including acid anions derived from a polyfluoroalkylcarboxylic acid having 1 to 9 carbon atoms, a polyfluoroalkylsulfonic acid having 1 to 9 carbon atoms, boron tetrafluoride, tetraphenylboron, hexafluorophosphoric acid, an aromatic carboxylic acid, an aromatic sulfonic acid, etc. Hexafluorophosphoric acid is preferable from the viewpoint of crystallinity.

Specific examples of the diazonium salt represented by the general formula (4) or (5) are illustrated below, but they should not be construed to limit the scope of the invention.

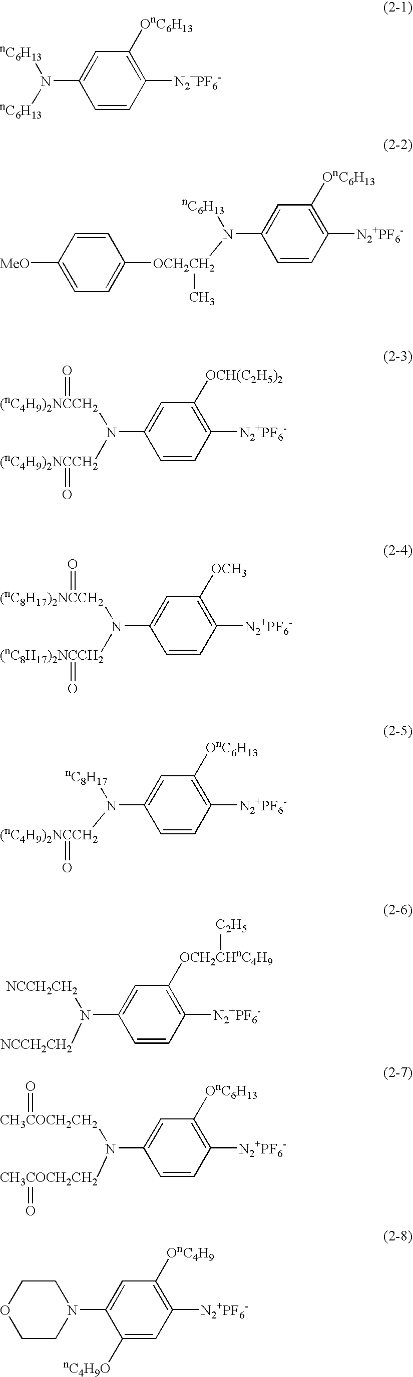

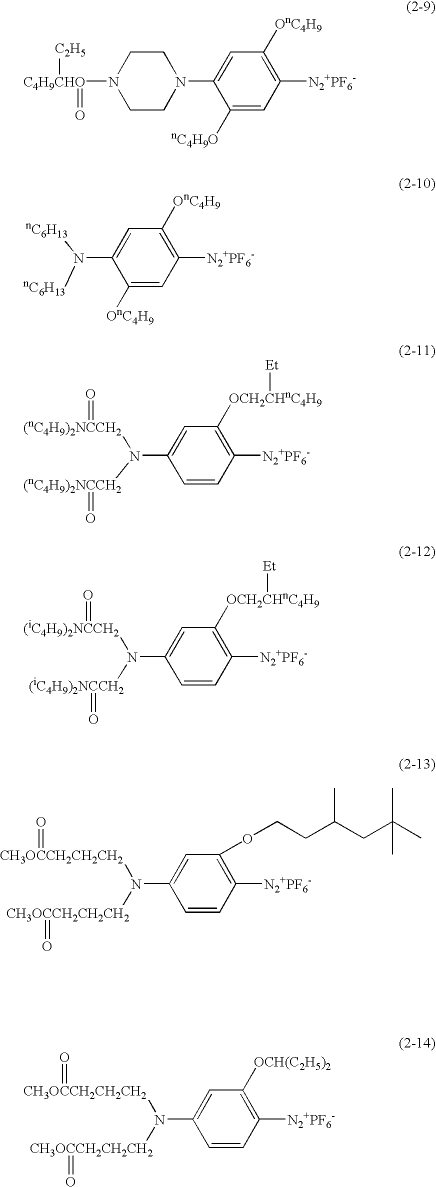

In the invention, the diazonium salt represented by the general formula (4) or (5) may be used singly, and a plurality of the diazonium salts may be used in combination.

The amount of the diazonium salt in the heat-sensitive recording layer for the invention is preferably 0.02 to 3 g/m², and more preferably 0.1 to 2 g/m².

It is preferred that the diazonium salt for the invention is encapsulated in microcapsules from the viewpoint of the shelf life. The microencapsulation method is not particularly limited, and may be a conventionally known method using a wall material such as gelatin, polyurea, polyurethane, polyimide, polyester, polycarbonate and melamine. The microencapsulation method is described in detail in JP-A No. 2-141279, etc. In the microencapsulation, a high boiling point organic solvent may be used as a dispersion solvent for the diazonium salt. The high boiling organic solvent is not particularly limited, and may be selected from conventionally known ones such as alkyl phthalates, phosphates, citrates, benzoates, alkylamides, aliphatic esters and trimesates. The organic solvent is described in detail in JP-A No. 7-17145, etc.

In the invention, an organic base such as a tertiary amine compound, a piperidine compound, a piperazine compound, an amidine compound, a formamidine compound, a pyridine compound, a guanidine compound and a morpholine compound is preferably used to accelerate the coupling reaction.

Specific examples of the organic base include piperazine compounds such as N,N′-bis(3-phenoxy-2-hydroxypropyl)piperazine, N,N′-bis[3-(p-methylphenoxy)-2-hydroxypropyl]piperazine, N,N′-bis[3-(p-methoxyphenoxy)-2-hydroxypropyl]piperazine, N,N′-bis(3-phenylthio-2-hydroxypropyl)piperazine, N,N′-bis [3-(β-naphthoxy)-2-hydroxypropyl]piperazine, N-3-(β-naphthoxy)-2-hydroxypropyl-N′-methylpiperazine and 1,4-bis{[3-(N-methylpiperazino)-2-hydroxy]propyloxy}benzene; morpholine compounds such as N-[3-(β-naphthoxy)-2-hydroxy]propylmorpholine, 1,4-bis[(3-morpholino-2-hydroxy)propyloxy]benzene and 1,3-bis[(3-morpholino-2-hydroxy)propyloxy]benzene; piperidine compounds such as N-(3-phenoxy-2-hydroxypropyl)piperidine and N-dodecylpiperidine; triphenylguanidine; tricyclohexylguanidine; dicyclohexylphenylguanidine; 2-N-methyl-N-benzylaminoethyl 4-hydroxybenzoate; 2-N,N-di-n-butylaminoethyl 4-hydroxybenzoate; 4-(3-N,N-dibutylaminopropoxy)benzenesulfonamide; 4-(2-N,N-dibutylaminoethoxycarbonyl)phenoxyacetic acid amide; etc. The organic bases are described in detail in JP-A Nos. 57-123086, 60-49991 and 60-94381, Japanese Patent Application Nos. 7-228731, 7-235157 and 7-235158, etc. The organic bases may be used singly or in combination. The amount of the organic base used in the invention is not particularly limited, and preferably 1 to 30 mol per 1 mol of the diazonium salt.

The coupler for use in the invention may be solid-dispersed with the other components by a sand mill, etc. after adding a water-soluble polymer, and may be emulsified with an appropriate emulsifying aid to be used as an emulsion. Methods for the solid dispersion and the emulsification are not particularly limited, and may be selected from conventionally known methods. The methods are described in JP-A Nos. 59-190886, 2-141279 and 7-17145 in detail.

In the invention, a color-forming aid may be used in addition to the compound represented by any one of the general formulae (1) to (3) to accelerate the color-developing reaction. Examples of the color-forming aid include phenol derivatives, naphthol derivatives, alkoxy-substituted benzenes, alkoxy-substituted naphthalenes, hydroxy compounds, carboxylic amide compounds, sulfonamide compounds, etc. It is considered that such color-forming aids lower the melting point of the coupler or the basic substance, or increase the heat-permeability of the microcapsule wall, thereby providing the high color density.

In the heat-sensitive recording material of the invention, the heat-sensitive recording layer with a solid content of 2 to 30 g/m² may be formed by the steps of preparing a coating liquid containing the diazonium salt, the compound represented by any of the general formulae (1) to (3) and the other additives; applying the coating liquid onto the support of a paper, synthetic resin film, etc. by bar coating, blade coating, air-knife coating, gravure coating, roll coating, spray coating, dip coating, curtain coating, etc.; and drying the applied liquid.

A binder is not particularly limited in the invention, and may be a conventionally known one such as polyvinyl alcohol, hydroxyethylcellulose, methylcellulose, carboxymethylcellulose, gelatin and a styrene-acrylic acid copolymer. The binder is described in detail in JP-A No. 2-141279, etc. Further, an organic or inorganic pigment, a stabilizer, an oxidation inhibitor, etc. may be added to the heat-sensitive recording material of the invention if necessary.

In the heat-sensitive recording material of the invention, the diazonium salt, the compound represented by any one of the general formulae (1) to (3), etc. may be contained in the same layer as described above, or in different layers respectively.

The support for use in the invention may be a conventionally known one, and specific examples thereof include neutral papers, acidic papers, reclaimed papers, polyolefin resin-laminated papers, synthetic papers, polyester films, cellulose derivative films such as cellulose triacetate films, polyolefin films such as polystyrene films, polypropylene films and polyethylene films, etc. These supports may be used singly, or laminated with each other to be used. The thickness of the support may be 20 to 200 μm. An intermediate layer may be disposed between the support and the heat-sensitive recording layer. The intermediate layer is described in JP-A No. 61-54980, etc.

In the heat-sensitive recording material of the invention, it is preferable that a protective layer is formed on the heat-sensitive recording layer, and it is more preferable that the protective layer is laminated to the heat-sensitive recording layer. The protective layer is composed of a water-soluble polymer compound, a pigment, etc. The protective layer preferably contains a compound with an ultraviolet ray transmittance-controlling function to obtain both the light resistance and light fixation property. A heat-sensitive recording material comprising the compound with the ultraviolet ray transmittance-controlling function is described in detail in JP-A No. 7-276808.

The heat-sensitive recording material of the invention can be used as a multicolor heat-sensitive recording material. The multicolor heat-sensitive recording material (heat-sensitive recording material) is described in JP-A Nos. 4-135787, 4-144784, 4-144785, 4-194842, 4-247447, 4-247448, 4-340540, 4-340541 and 5-34860, etc. Specifically, the multicolor heat-sensitive recording material can be obtained by laminating heat-sensitive recording layers to develop different colors. A layer structure of the multicolor heat-sensitive recording material is not particularly limited. For example, the multicolor heat-sensitive recording material may have a layer structure where two heat-sensitive recording layers (Layers B and C), which each comprise a combination of a diazonium salt having a different photosensitive wavelength and a coupler that thermally reacts therewith to develop a different color, are laminated with a heat-sensitive recording layer (Layer A) comprising a combination of an electron donating colorless dye and an electron-accepting compound. Specifically, the layer structure may be such that the first heat-sensitive recording layer (Layer A) comprising the electron donating colorless dye and the electron-accepting compound, the second heat-sensitive recording layer (Layer B) comprising a diazonium salt having a maximum absorption wavelength of 360±20 nm and a coupler that thermally reacts with the diazonium salt to develop a color, and the third heat-sensitive recording layer (Layer C) comprising a diazonium salt having a maximum absorption wavelength of 400±20 nm and a coupler that thermally reacts with the diazonium salt to develop a color are disposed on the support. In this example, full color image record can be achieved by selecting the color hues of the heat-sensitive recording layers to be yellow, magenta and cyan, which are three primary colors in the subtractive color mixture.

A recording method using this multicolor heat-sensitive recording material may be as follows. Firstly, the third heat-sensitive recording layer (Layer C) is heated, whereby the diazonium salt and the coupler contained in the layer are reacted to develop a color. Next, the unreacted diazonium salt in Layer C is decomposed and fixed by irradiation with light of 400±20 nm. Then, the diazonium salt and the coupler in the second heat-sensitive recording layer (Layer B) is colored by applying heat sufficient for the color development to the layer. In this step, Layer C is also heated strongly, however, Layer C produces no color because the diazonium salt in Layer C is already decomposed (light-fixed) to lose the color-developing ability. Further, the diazonium salt contained in Layer B is decomposed by irradiation with light of 360±20 nm, and finally, the first heat-sensitive recording layer (Layer A) is colored by applying heat sufficient for the color development to the layer. In this step, Layers C and B are also heated strongly, however, Layers C and B produce no color because the diazonium salts therein are already decomposed to lose the color-developing ability.

Alternatively, each of the heat-sensitive recording layers (Layers A, B and C disposed in this order from the upper side) may comprise a combination of a diazonium salt having a different photosensitive wavelength and a coupler that thermally reacts with the diazonium salt to develop a different color. In particular, such a layer structure is required in the case where the influence on image quality of the surface roughness of the support is reduced by using the lowermost layer as a yellow color-developing layer low in visibility to improve the image quality. In the case where all the recording layers (Layers A, B and C) are diazo-based, heat-sensitive recording layers, Layers A and B have to be light-fixed after the color development. Layer C need not to be light-fixed.

Used as a light source for the light fixation are a fluorescent lamp, a xenon lamp, a mercury lamp, etc. It is preferable that the emission spectrum of the light source approximately corresponds to the absorption spectrum of the diazonium salt used in the heat-sensitive recording material to efficiently carry out the light fixation.

The heat-sensitive recording material of the invention may be used as a photothermographic material, which forms an image such that the diazonium salt in portions other than the image-forming portions is decomposed by exposing the material through an original to form a latent image, and then the material is heat-developed while heating the entire material.

The compound represented by any one of the general formulae (1) to (3) may be synthesized by a known method.

### EXAMPLES

The present invention will be described in more detail below with reference to examples, but they should not be construed to limit the scope of the invention. Incidentally, the term “parts” in Examples means “parts by weight”.

### Example 1

[Preparation of Microcapsule Liquid A]

2.8 parts of the diazonium salt of the exemplified compound (2-3) and 10 parts of tricresyl phosphate were added to 19 parts of ethyl acetate and uniformly mixed. Then, 7.6 parts of Takenate D-110N produced by Takeda Chemical Industries, Ltd. was added as a wall material to the resultant mixture and uniformly mixed to obtain Liquid I.

Next, 46 parts of an 8 weight % gelatin phthalate aqueous solution, 17.5 parts of water and 2 parts of a 10% sodium dodecylbenzenesulfonate aqueous solution were added to Liquid I, and dispersed and emulsified under conditions of 40° C. and 10,000 r.p.m. for 10 minutes. After 20 parts of water was added to the obtained emulsion and made uniform, a microcapsulation reaction was carried out while stirring the emulsion at 40° C. for 3 hours, to obtain Microcapsule liquid A. The average diameter of the microcapsules in the Microcapsule liquid A was 0.8 to 0.9 μm.

[Preparation of Coupler Emulsion B]

3.0 parts of the coupler of the exemplified compound (1-16), 3.0 parts of triphenylguanidine, 0.5 parts of tricresyl phosphate and 0.24 parts of diethyl maleate were dissolved in 10.5 parts of ethyl acetate to prepare Liquid II.

Then, 49 parts of a 15 weight % lime-treated gelatin aqueous solution, 9.5 parts of a 10% sodium dodecylbenzenesulfonate aqueous solution and 35 parts of water were uniformly mixed at 40° C., thereto was added Liquid II, and the resulting mixture was dispersed and emulsified by a homogenizer under conditions of 40° C. and 10,000 r.p.m. for 10 minutes. Thus-obtained emulsion was stirred at 40° C. for 2 hours to remove ethyl acetate, and the weight of the vaporized ethyl acetate and water was compensated by water addition, to obtain Coupler emulsion B.

[Preparation of Heat-sensitive Recording Layer Coating Liquid C]

3.6 parts of Microcapsule liquid A, 3.3 parts of water and 9.5 parts of Coupler emulsion B were uniformly mixed to obtain Heat-sensitive recording layer coating liquid C.

[Preparation of Protective Layer Coating Liquid D]

100 parts of a 6% aqueous solution of itaconic acid-modified polyvinyl alcohol (KL-318: trade name, produced by Kuraray Co., Ltd.) and 10 parts of a 30% dispersion of epoxy-modified polyamide (FL-71: trade name, produced by Toho Chemical Industry Co., Ltd.) were mixed, and the resulting liquid was uniformly mixed with 15 parts of a 40% zinc stearate dispersion (Hydrin Z: trade name, produced by Chukyo Yushi Co., Ltd.) to obtain Protective layer coating liquid D.

[Coating]

Heat-sensitive recording layer coating liquid C and Protective layer coating liquid D were each applied onto a printing paper support of a polyethylene-laminated wood free paper by a wire bar and dried at 50° C. sequentially in this order, to obtain a desired heat-sensitive recording material. The solid contents of the applied coating liquids C and D were 8.0 g/m² and 1.2 g/m², respectively.

[Light Resistance Test of Image]

The heat-sensitive recording material was subjected to thermal printing by using a thermal head (model KST) manufactured by Kyocera Corporation. The applied electric power and the pulse width for the thermal head were selected so that the recording energy per unit area was 50 mJ/mm². The entire surface of the material was irradiated for 15 seconds by a light of an ultraviolet lamp having an emission center wavelength of 365 nm and an output power of 40 W. The density of the obtained image portion of the material was measured by a Macbeth densitometer.

Then, after the colored image portion was irradiated with a light of 30,000 lux continuously for 24 hours by a fluorescent lamp light resistance tester, the density of the image portion was measured. The heat-sensitive recording material high in the image density after the light irradiation is excellent in the light resistance of image portion.

### Examples 2 to 10

Heat-sensitive recording materials were produced and evaluated in the same manner as Example 1 except for using couplers shown in Table 1 instead of the exemplified compound (1-16).

### Comparative Examples 1 and 2

Heat-sensitive recording materials were produced and evaluated in the same manner as Example 1 except for using couplers (3-1) and (3-2) represented by the following formulae instead of the exemplified compound (1-16).

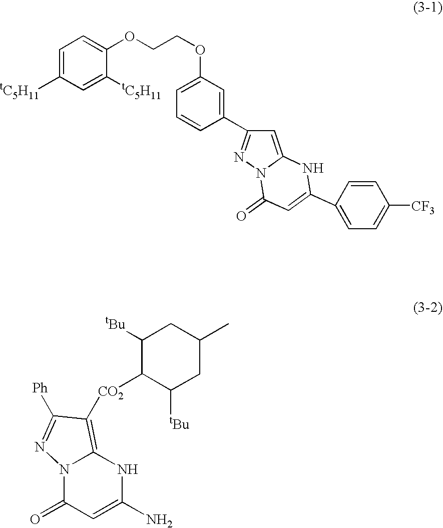

The maximum absorption wavelength λₘₐₓ of the colored image portion and the results of the light resistance test of each material were shown in Table 1.

TABLE 1

| | | | λₘₐₓ of | Light resistance test | |
|---|---|---|---|---|---|
| | | | image | Density of image portion | |
| | | Diazonium | portion | Before light | After light |
| | Coupler | salt | (nm) | irradiation | irradiation |
| Example 1 | 1-16 | 2-3 | 542 | 1.50 | 1.45 |
| Example 2 | (1-3 ) | (2-3) | 537 | 1.42 | 1.37 |
| Example 3 | (1-5 ) | (2-3) | 536 | 1.45 | 1.39 |
| Example 4 | (1-8 ) | (2-3) | 535 | 1.40 | 1.33 |
| Example 5 | (1-12) | (2-3) | 537 | 1.45 | 1.39 |
| Example 6 | (1-13) | (2-3) | 538 | 1.43 | 1.35 |
| Example 7 | (1-32) | (2-3) | 532 | 1.52 | 1.42 |
| Example 8 | (1-33) | (2-3) | 547 | 1.41 | 1.33 |
| Example 9 | (1-34) | (2-3) | 544 | 1.42 | 1.33 |
| Example 10 | (1-64) | (2-3) | 540 | 1.42 | 1.30 |
| Comparative | (3-1 ) | (2-3) | 612 | 1.38 | 1.05 |
| Example 1 | | | | | |
| Comparative | | | | | |
| Example 2 | (3-2) | (2-3) | 545 | 1.20 | 0.85 |

As shown in the results, the magenta color-developing type, heat-sensitive recording materials according to the invention, which used the compounds represented by any one of the general formulae (1) to (3) as a coupler, were high in the color density. Further, in each of the recording materials of the invention, the density of the image portion was reduced only slightly by the light irradiation using the fluorescent lamp. Thus, the recording materials of the invention were considered to be excellent in the light resistance of image.

The heat-sensitive recording material of the invention is magenta color-developing type, high in the image density, and excellent in the light resistance of image.

What is claimed is:

1. A heat-sensitive recording material comprising:
a support; and
a heat-sensitive recording layer formed on the support, the heat-sensitive recording layer containing a diazonium salt and a coupler that reacts with the diazonium salt to develop color, wherein the coupler contains a compound represented by the following general formula (1): 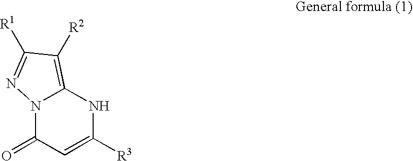
wherein R¹ and R² each independently represent one selected from the group consisting of a hydrogen atom, a halogen atom, an aryl group, an alkyl group, a cyano group, an acyl group, a carbamoyl group, an alkoxycarbonyl group, an aryloxycarbonyl group, an acyloxy group, an alkoxy group, an aryloxy group, an alkylthio group, an arylthio group, a sulfamoyl group, an alkylsulfonyl group, an arylsulfonyl group, an alkylphosphoryl group, an arylphosphoryl group, and an amino group; and R³ represents one selected from the group consisting of an alkoxy group, an aryloxy group, and an alkylamino group.

2. The heat-sensitive recording material of claim 1, wherein the coupler is contained in the heat-sensitive recording layer in an amount of 0.02 to 5 g/m².

3. The heat-sensitive recording material of claim 1, wherein the coupler is contained in the heat-sensitive recording layer in an amount of 0.1 to 4 g/m².

4. The heat-sensitive recording material of claim 1, wherein the diazonium salt is encapsulated in microcapsules.

5. The heat-sensitive recording material of claim 1, wherein the diazonium salt contains a compound represented by the following general formula (4): 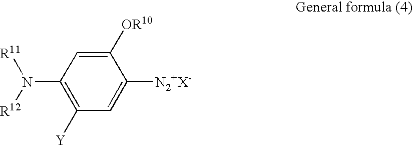
wherein R¹⁰, R¹¹ and R¹² each independently represent an alkyl group or an aryl group; Y represents a hydrogen atom, an alkoxy group, or an aryloxy group; and X⁻ represents an anion.

6. The heat-sensitive recording material of claim 5, wherein the diazonium salt is encapsulated in microcapsules.

7. The heat-sensitive recording material of claim 1, wherein the diazonium salt contains a compound represented by the following general formula (5): 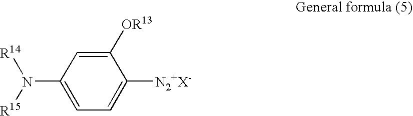
wherein R¹³, R¹⁴ and R¹⁵ each independently represent an alkyl group or an aryl group; and X⁻ represents an anion.

8. The heat-sensitive recording material of claim 7, wherein the diazonium salt is encapsulated in microcapsules.

9. The heat-sensitive recording material of claim 1, wherein the coupler contains a compound represented by the following general formula (2): 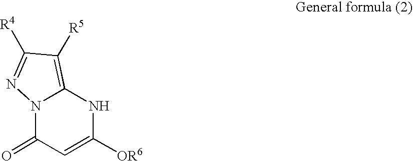
wherein R⁴ and R⁵ each independently represent one selected from the group consisting of a hydrogen atom, a halogen atom, an aryl group, an alkyl group, a cyano group, an acyl group, a carbamoyl group, an alkoxycarbonyl group, an aryloxycarbonyl group, an acyloxy group, an alkoxy group, an aryloxy group, an alkylthio group, an arylthio group, a sulfamoyl group, an alkylsulfonyl group, an arylsulfonyl group, an alkylphosphoryl group, an arylphosphoryl group, and an amino group; and R⁶ represents an alkyl group.

10. The heat-sensitive recording material of claim 9, wherein the diazonium salt is encapsulated in microcapsules.

11. The heat-sensitive recording material of claim 9, wherein the diazonium salt contains a compound represented by the following general formula (4): 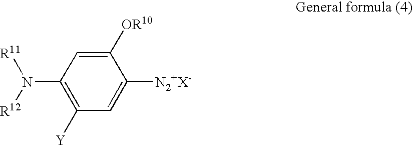
wherein R¹⁰, R¹¹ and R¹² each independently represent an alkyl group or an aryl group; Y represents a hydrogen atom, an alkoxy group, or an aryloxy group; and X⁻ represents an anion.

12. The heat-sensitive recording material of claim 11, wherein the diazonium salt is encapsulated in microcapsules.

13. The heat-sensitive recording material of claim 9, wherein the diazonium salt contains a compound represented by the following general formula (5): 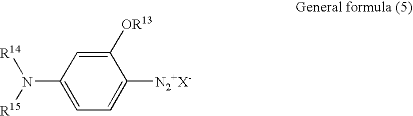
wherein R¹³, R¹⁴ and R¹⁵ each independently represent an alkyl group or an aryl group; and X⁻ represents an anion.

14. The heat-sensitive recording material of claim 13, wherein the diazonium salt is encapsulated in microcapsules.

15. The heat-sensitive recording material of claim 1, wherein the coupler contains a compound represented by the following general formula (3): 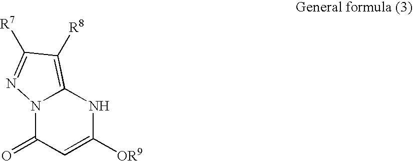
wherein R⁷ represents one selected from the group consisting of a hydrogen atom, an aryl group, an alkyl group, an alkoxy group, and an amino group; R⁸ represents one selected from the group consisting of a hydrogen atom, a halogen atom, an aryl group, an alkyl group, an alkoxy group, an aryloxy group, an alkylthio group, an arylthio group, and an amino group; and R⁹ represents an alkyl group.

16. The heat-sensitive recording material of claim 15, wherein the diazonium salt is encapsulated in microcapsules.

17. The heat-sensitive recording material of claim 15, wherein the diazonium salt contains a compound represented by the following general formula (4): 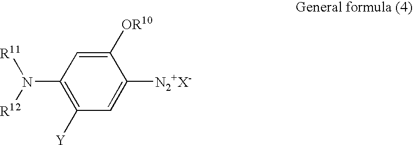
wherein R¹⁰, R¹¹ and R¹² each independently represent an alkyl group or an aryl group; Y represents a hydrogen atom, an alkoxy group, or an aryloxy group; and X⁻ represents an anion.

18. The heat-sensitive recording material of claim 17, wherein the diazonium salt is encapsulated in microcapsules.

19. The heat-sensitive recording material of claim 15, wherein the diazonium salt contains a compound represented by the following general formula (5): 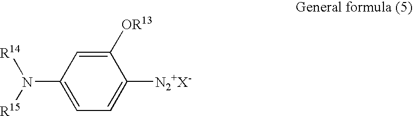
wherein R¹³, R¹⁴ and R¹⁵ each independently represent an alkyl group or an aryl group; and X⁻ represents an anion.

20. The heat-sensitive recording material of claim 19, wherein the diazonium salt is encapsulated in microcapsules.
